(19) United States
(12) Patent Application Publication
(10) Pub. No.: US 2008/0209904 A1
(43) Pub. Date: Sep. 4, 2008

(54) Systems and Methods for Generating Electricity Using a Stirling Engine

(76) Inventor: Theodore S. Sumrall, Fort Walton Beach, FL (US)

Correspondence Address: SUTHERLAND ASBILL & BRENNAN LLP, 999 PEACHTREE STREET, N.E., ATLANTA, GA, 30309, US

(21) Appl. No.: 11/858,458

(22) Filed: Sep. 20, 2007

Related U.S. Application Data
(60) Provisional application No. 60/846,554, filed on Sep. 22, 2006.

(51) Int. Cl. F02G 1/043

(52) U.S. Cl. 60/517; 290/1 R

(57) ABSTRACT

A system for generating power including a Stirling engine, and a high temperature source thermally coupled to a hot chamber of the Stirling engine wherein the high temperature source comprises heat from below the earth's surface. In an embodiment of the system, the high temperature source may be a dry hole, oil well, or gas well.

### RELATED APPLICATION DATA

The present application also claims priority to U.S. Provisional Application No. 60/846,554 entitled “Systems and methods for generating electricity using natural water sources and heat from the earth in conjunction with a Stirling engine” filed on Sep. 22, 2006, which is incorporated herein by reference in its entirety.

### GOVERNMENT CONTRACT

The U.S. Government has a license in this application pursuant to Contract Number F08630-03-C-0133 awarded by the U.S. Department of Defense.

### TECHNICAL FIELD

This application relates generally to the field of electricity generation through the use of heat from within the earth's crust and more particularly to the use of Stirling engines in combination with heat from within the earth's crust for electricity generation.

### BACKGROUND OF THE APPLICATION

Conventional systems for generating electricity for consumption and use by the public include nuclear power, fossil fuel powered steam generation plants and hydroelectric power. Operation and maintenance of these systems is expensive and utilizes significant natural resources and in some cases results in excessive pollution, either through hydrocarbon combustion or spent nuclear fuel rod disposal. Oil may be considered a non-renewable source of power, which leaves non-petroleum producing countries at the mercy of those which produce petroleum.

Nuclear power also has its problems. Currently, nuclear material is mined from the earth, refined and then utilized in a nuclear power plant. Sufficient amounts of Uranium-235 and/or plutonium are confined to a small space, often in the presence of a neutron moderator. The subsequent reaction produces heat which is converted to kinetic energy by means of a steam turbine and then a generator for electricity production. Nuclear power currently provides about 17% of the United States electricity and 7% of global energy. The cost for bringing a nuclear power plant on line is approximately $10-30 Billion. An international effort into the use of nuclear fusion for power is ongoing, but is not expected to be available in commercially viable form for several decades.

Therefore, there is a need in the art for systems and methods for generating clean electrical power cheaply without relying upon the import of petroleum materials or building of multi-billion dollar power plants.

### SUMMARY OF THE APPLICATION

In one embodiment of the application, a system for generating power includes a Stirling engine, and a high temperature source thermally coupled to a hot chamber of the Stirling engine wherein the high temperature source comprises heat from below the earth's surface. In an embodiment of the system, the high temperature source may be a dry hole, oil well, or gas well.

Another embodiment of the application may include a system for generating power that includes a Stirling engine including a high temperature source thermally coupled to a hot chamber of the Stirling engine wherein the high temperature source is heat from below the earth's surface, and a low temperature source thermally coupled to the cold chamber wherein the low temperature source is a body of water.

In yet another embodiment of the application, a method for producing electrical power includes providing a Stirling engine that includes a hot chamber and a cold chamber, thermal coupling the hot chamber to a high temperature source wherein the high temperature source comprises heat from below the earth's surface, and generating electricity through a electric generator attached to the Stirling engine.

### DETAILED DESCRIPTION OF THE DRAWINGS

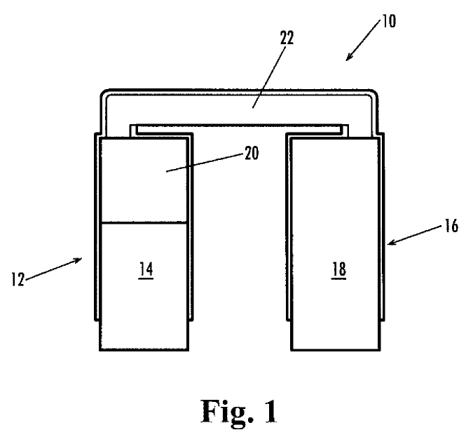

FIG. 1 is a Stirling engine cycle according to an exemplary embodiment of the present application.

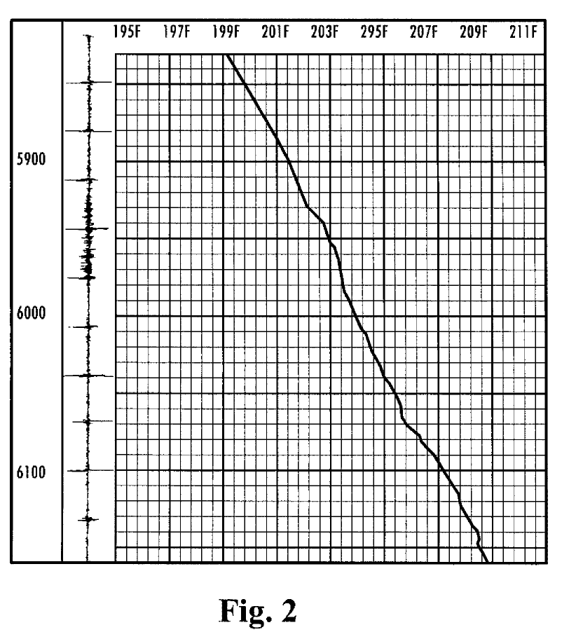

FIG. 2 is an illustration of temperatures under the earth's surface according to an exemplary embodiment of the present application.

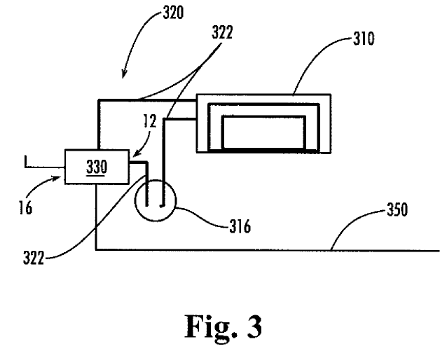

FIG. 3 is an illustration of a Stirling engine system according to an exemplary embodiment of the present application.

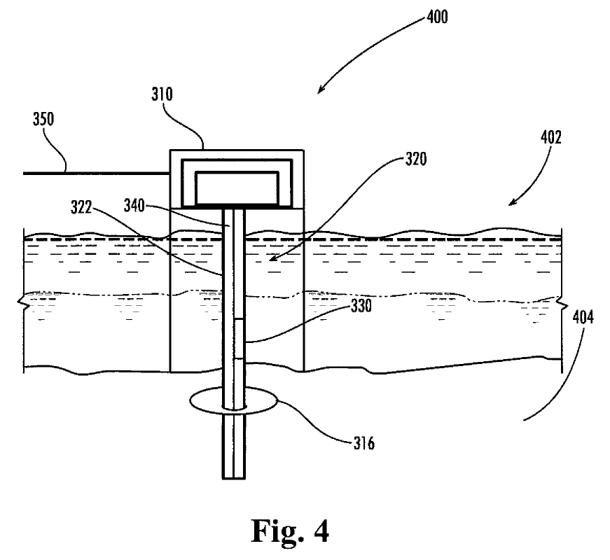

FIG. 4 is an illustration of a Stirling engine system using a body of water according to an exemplary embodiment of the present application.

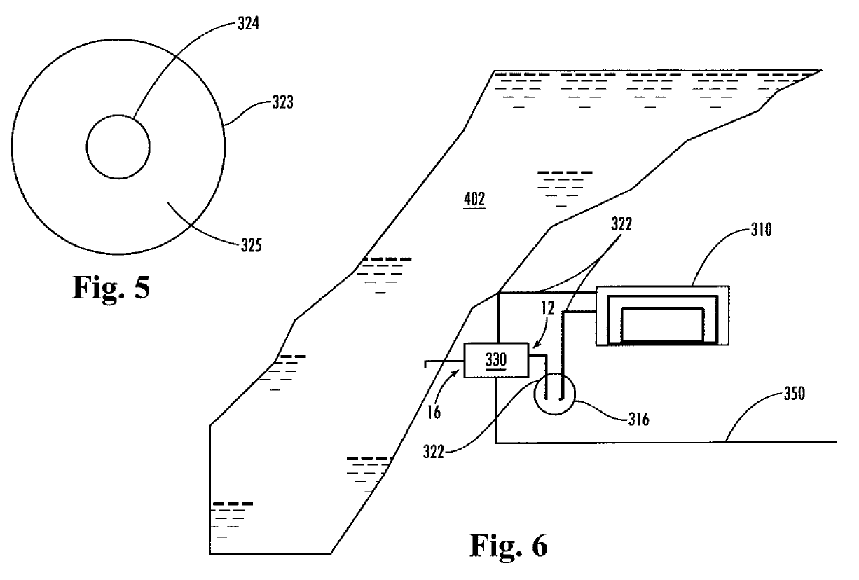

FIG. 5 is an illustration of a pipe including an interior pipe and an exterior pipe according to an embodiment of the present application.

FIG. 6 is an illustration of a Stirling engine system using a body of water according to an exemplary embodiment of the present application.

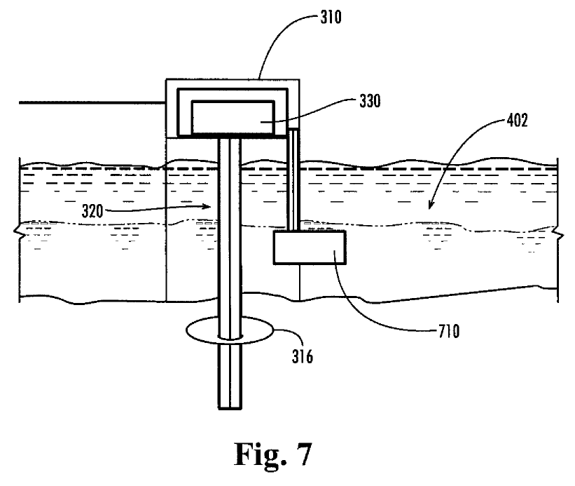

FIG. 7 is an illustration of a Stirling engine system using a chiller according to an exemplary embodiment of the present application.

### DETAILED DESCRIPTION OF THE APPLICATION

The present application now will be described more fully hereinafter with reference to the accompanying drawings, in which an exemplary embodiment of the application is shown. This application may, however, be embodied in many different forms and should not be construed as limited to the embodiments set forth herein; rather, this embodiment is provided so that this disclosure will be thorough and will fully convey the scope of the application to those skilled in the art. Like numbers refer to like elements throughout.

Stirling engine technology is a functional, viable and continuous long-term power source. Due to the accessibility of temperature gradients occurring in natural and man-made environments, Stirling engines can provide a continuous power supply that may be converted to the form of electricity through an electric generator or other means. One of the most abundant, common, and accessible sources of energy is environmental heat, especially heat contained within the earth's crust.

Stirling engines are known to those of ordinary skill in the art and will not be explained in detail herein. FIG. 1 illustrates an exemplary embodiment of the Stirling engine 10 including a cylindrical hot chamber 12 with a piston 14, a cylindrical cold chamber 16 with a piston 18, a gas 20, and a connecting pipe 22. A high temperature source may be applied or thermally coupled to the hot chamber 12 to increase the temperature of the gas 20 within the hot chamber 12. Heat from the high temperature source may be transferred to the gas 20 through conduction, convection, radiation or any other means. A low temperature source may be applied or thermally coupled to the cold chamber 16 to decrease the temperature of the gas 20 within the cold chamber 16. Heat from the gas 20 may be extracted by the cold temperature source through conduction, convection, radiation or any other means.

As known by those of ordinary skill in the art, the Stirling engine 10 operates by pressurizing and depressurizing the gas through the application of a high temperature source to the hot chamber 12 and application of a low temperature source to the cold chamber 16. The efficiency and power generated by the Stirling engine 10 also may be increased through the use of an increased high temperature source and a decreased low temperature source to create a substantial temperature gradient across the hot chamber 12 and the cold chamber 16. The temperature gradient across the hot and cold chambers will increase the pressure distribution across the engine which causes the pistons 14, 18 to more actively move. The pistons 14, 18 may be connected to a shaft such that the movement of the pistons causes the shaft to rotate. An electric generator may be attached to the shaft to convert the mechanical energy of the rotating shaft to electricity.

It should be understood that this application is not limited to the Stirling engine as configured in FIG. 1. Any engine that uses the pressurizing and depressurizing of gas is contemplated herein including Displacer-type Stirling engines, two-piston Stirling engines, and any combination thereof.

The high temperature source may be provided from within the earth's crust. The earth provides a continuous, inexpensive source of extremely high heat. As illustrated in FIG. 2, the temperature within the earth generally increases towards the core of the earth at an average rate of approximately 1 degree Fahrenheit for every 60 feet of depth. Therefore, locations deep within the earth may be used as the high temperature source for the hot chamber 12 of the Stirling engine. Locations within the earth may be accessed through drilling or other means for creating a hole in the ground and water or some other type of heat transfer medium circulated through the hole and brought to or near the surface to allow for heat transfer to occur by the employment of high efficiency pumps or some other method.

Certain holes, commonly referred to as dry holes may be used to access the high temperatures within the earth's crust. Dry holes typically exist from the unsuccessful efforts of the petroleum industry to locate oil or gas. The petroleum industry drills wells deep into the earth's crust for the exploration for petroleum. A large percentage of exploration wells drilled throughout the world do not locate petroleum and are thereby indicated as “dry holes.” Dry holes provide relatively easy access to the subterranean levels and high temperature conditions. Dry holes may be located on land or in a body of water. Dry holes may reach depths in excess of 30,000 feet. However, one of ordinary skill in the art will appreciate that dry holes may be any depth. As shown in FIG. 2, temperatures in the dry holes can reach extremely high temperatures. In the exemplary embodiment of FIG. 2, temperatures in that particular dry hole are approximately 209 degrees F. at 6100 feet. One of ordinary skill in the art will appreciate that the temperatures in the dry hole are not limited to the temperatures depicted in FIG. 2 but may be any temperature. One of ordinary skill in the art will appreciate that this application is not limited to the use of dry holes and may include any hole in the earth's crust which can provide a heat source including holes drilled for use by a Stirling engine as well as expended oil and gas wells which are wells which have essentially exhausted their oil and/or gas production.

Referring to the exemplary embodiment of FIG. 3, the Stirling engine system may include a pump station 310, a pipe system 320, a Stirling engine 330, and a heat transfer heat transfer fluid 340. The pump station 310 may include a pump and associated housing for the pump. The pump may be any commercially available or specially designed pump that is capable of forcing heat transfer heat transfer fluid to flow at a suitable volumetric rate. The pump station 310 is connected to the pipe system 320. The pipe system 320 includes at least one pipe 322. The pipe 322 may include an inner bore for carrying heat transfer heat transfer fluid 340 to be heated by the earth. The inner bore may be any suitable diameter that allows sufficient heat transfer heat transfer fluid 340 to be pumped through the pipe system. The pipe 322 extends from the pump station 310 into the hole 316 and may be substantially U-shaped such that the pipe 322 ascends out of the hole.

The pipe system 320 may interface a hot chamber 12 of the Stirling engine 330. The inner bore of the pipe 322 of the pipe system 320 is accessible to an input of the hot chamber 12 of the Stirling engine 330. The pipe system 320 extends from an output of the hot chamber 12 of the Stirling engine 330 to return to the pump station 310.

In another exemplary embodiment illustrated in FIG. 5, the pipe system may include an exterior pipe 323 and an interior pipe 324 such that an annulus 325 exists between the interior pipe 324 and the exterior pipe 323. In this exemplary embodiment, the heat transfer heat transfer fluid 340 may be pumped into the hole through the annulus 325, and the heat transfer heat transfer fluid 340 heated by the earth may be pumped out the hole through the interior pipe 324 to the hot chamber 12 of the Stirling engine 330. It should be understood that the pipe system may be in any configuration. For example, the heat transfer heat transfer fluid 340 may be pumped into the hole through the exterior pipe 323, and the heat transfer heat transfer fluid 340 heated by the earth may be pumped out the hole through the annulus 325 to the hot chamber 12 of the Stirling engine 330. The pipe system 320 may include any number of pipes in any configuration for carrying the heat transfer heat transfer fluid to the high temperature source and to the hot chamber of the Stirling engine.

The heat transfer heat transfer fluid 340 is forced through the pump using the pump station 310. The heat transfer heat transfer fluid 340 is circulated through the pipe 322, the hot chamber 12 of the Stirling engine 330, and the pump station 310 using the pump. Additional heat transfer heat transfer fluid may be added to the pipe system 320 either continuously or when needed by the system to account for any loss of heat transfer heat transfer fluid during operation of the pipe system and pump station. However, one of ordinary skill in the art will recognize that other methods of bringing the heated heat transfer heat transfer fluid to or near the surface may be employed.

The heat transfer heat transfer fluid 340 within the pipe 322 is heated by the earth as it descends from the pump station 310 towards the bottom of the hole 316. The heat transfer heat transfer fluid 340 may be heated to approach the temperature of the earth in the hole 316. In an exemplary embodiment, the heat transfer heat transfer fluid 340 may be heated in excess of 200 degrees Fahrenheit. After the heat transfer heat transfer fluid 340 reaches the lowest point of the pipe 322, the heated heat transfer heat transfer fluid then ascends out of the hole 316 and into the input of the hot chamber 12 of the Stirling engine 330.

The heated heat transfer heat transfer fluid in the pipes 322 may be the high temperature source and is thermally coupled to the hot chamber 12 of the Stirling engine 330. The heat from the heat transfer heat transfer fluid 340 may access the hot chamber 12 of the Stirling engine 330. After transferring heat to the hot chamber 12 the heat transfer heat transfer fluid 340 may continue through the pipe 322. The heat transfer heat transfer fluid 340 continues to the pump station 310 to close the pumping cycle of the heat transfer heat transfer fluid. The pump station 310 may include any pump that is operable to pump the heat transfer heat transfer fluid 340 through the pipe system 320 and the Stirling engine 330 at an appropriate volumetric rate. Furthermore, the Stirling engine system may operate as either a closed system or an open system. Any method of drawing heat from within the earth's crust such that the heat can be used as the high temperature source and applied or thermally coupled to the hot chamber is contemplated herein.

The heat transfer heat transfer fluid 340 may include any heat transfer fluid that is capable of being heated by the earth and capable of retaining a substantial portion of the heat for delivery to the hot chamber of the Stirling engine 330. In an exemplary embodiment, the heat transfer heat transfer fluid is water, however, other heat transfer fluids may be employed to reduce corrosion and to allow heating well above the boiling point of water.

In another embodiment of the Stirling engine system, the high temperature source for the hot chamber 12 may be from a mud pit. Mud from the mud pit is used as a drilling heat transfer fluid for oil well drilling. The mud extends to the bottom of the hole being drilled for oil exploration. The mud is heated from the drilling and the high temperatures from within the earth's surface. The hot chamber 12 of the Stirling engine 330 may interface the mud pit to access the high temperature of the mud using the pipe system 320 or any other system.

The low temperature source may be any source having a temperature lower than the high temperature source. In an exemplary embodiment, the low temperature source may be the ambient air of the atmosphere. In another embodiment, the low temperature source may be a location just below the earth's surface that has a temperature lower than the ambient air.

In another exemplary embodiment, the Stirling engine system may be located in or near a body of water 402 including but not limited to an ocean, gulf, sea, lake, river, spring, creek, or any other relatively cooler body of water. The Stirling engine system may utilize the body of water 402 as the low temperature source for the Stirling engine 330.

The body of water 402 can provide significantly lower temperatures to the Stirling engine 330 to increase the temperature gradient. In a body of water 402, such as an ocean, gulf, sea, or lake, the temperature of the water decreases with depth. At a depth commonly referred to as the thermocline, the water temperature significantly decreases. The depth at which a thermocline occurs averages between 30 and 50 meters, and varies throughout the world. It is preferred for the low temperature source to be water at a depth below the thermocline to provide a continuous source of cold water, and preferably in a current to allow a continuous flow of cool water so that the water is not stagnant and therefore rises in temperature throughout energy production operations. Additionally, location of the power plant adjacent to some other surface body of relatively cooler water will allow the water to flow through the plant and then be discharged with minimal thermal change of the water.

The Stirling engine 330 may be located in the body of water 402 and in communication with the pipe system 320. The body of water 402 is used as the low temperature source for the cold chamber 16 of the Stirling engine. In the exemplary embodiment of FIG. 4, the Stirling engine 330 is located beneath the thermocline of the body of water 402 so that the cold chamber 16 may access the low temperature water below the thermocline. In an exemplary embodiment, the Stirling engine 330 may be located in a current stream in the body of water 402 to access a flow of the water. The body of water 402 provides the low temperature source for cold chamber 16 of the Stirling engine 330. The cold chamber 16 may be outwardly exposed to the water in the body of water 402. The cold chamber 16 may be sufficiently protected to prevent corrosion. The water in the body of water 402 also may be channeled into the cold chamber 16 of the Stirling engine. The cold chamber 16 may include an input for receiving the water and an output for exiting the cold water. The water may flow through the cold chamber 16 to provide the low temperature source to the cold chamber 16 of the Stirling engine.

In an exemplary embodiment, the high temperature source may be between 100 degrees Fahrenheit and 2200 degrees Fahrenheit and the low temperature source may be between approximately 0 and 130 degrees Fahrenheit. One of ordinary skill in the art will appreciate that the high temperature source and low temperature source are not limited to these temperature ranges but may be any appropriate temperature ranges. The temperature gradient between the hot chamber and the cold chamber may be between 470 and 68 degrees in the exemplary embodiment. One of ordinary skill in the art will appreciate that the temperature gradient is not limited to this range but may be any temperature gradient.

In another embodiment, the high temperature source may be used in conjunction with a steam powered generator. Heat transfer fluid may be pumped through a pipe system into the earth's crust. The heat transfer fluid may then be heated by the earth's crust and pumped to the surface. Using the high temperature source to heat the heat transfer fluid may minimize the power required to operate a steam powered generator by preheating the water to the steam plants. The cost of heating the heat transfer fluid to its boiling point, therefore, will be significantly reduced at hydrocarbon powered or other types of electrical plants if the heat transfer fluid can be brought to a higher temperature as a result of heating within the earth's crust. For example, if the heat transfer fluid is water, the high temperature source may heat the water to or near its boiling point. The water then could be converted to steam for use in the steam power generator. If the heat transfer fluid is a fluid such as oil that has a boiling point greater than water, the heat transfer fluid can be heated above 212 degrees Fahrenheit such that it can transfer heat through a heat exchanger to water in the steam powered generator to be converted to steam without the need of any or very little fossil fuels or other energy sources. The steam powered generator may be used in conjunction with the Stirling engine system or completely separate therefrom.

In another embodiment of the Stirling engine system illustrated in FIG. 6, the hole 316 may be located on the land proximate to a body of water. The hole 316 may provide the high temperature source for the hot chamber as described previously. The body of water 402 may provide the low temperature source for the cold chamber. The body of water 402 may be a river, spring, creek, lake, or any other cold water supply. The cold chamber 16 of the Stirling engine 330 is thermally coupled to the body of water 402. The cold chamber 16 may interface directly with the body of water 402 or the body of water may be directed to the cold chamber 16 using a pipe 322 of the pipe system 320 or other means of channeling the water such as a heat exchanger. The cold chamber 16 is cooled to approximately the temperature of the water interfacing the cold chamber. The electricity generated from an electric generator interfaced with the Stirling engine 330 may be transmitted through power lines 350 to any destination.

In another embodiment of the Stirling engine system illustrated in FIG. 7, the low temperature source for the cold chamber 16 may be water from a chiller device 810 residing below the surface of the earth. Due to the low temperatures below the earth's surface, the chiller device 810 may be used to lower the temperature of the water. In an exemplary embodiment, the chiller device may be placed at a depth up to approximately 300 feet below the surface. At approximately 300 feet below the surface, the temperature generally begins to increase with depth. One of ordinary skill in the art will appreciate that the 300 feet level is only an approximation and that the depth may vary depending on location on the earth and is therefore not limited to the 300 feet approximation. The chiller device 810 may be powered from electricity generated from the Stirling engine.

In another exemplary embodiment, the pipe system 320 may be positioned in the body of water. The pipe system 320 may form a closed loop with the cold chamber 16 of the Stirling engine 320 to continuously provide cold fluid to the cold chamber 16. The low temperature source of the body of water may cool the fluid in the pipe 322 as the cold fluid is pumped through the pipe system 320 to the desired location in the body of water 402. The cold fluid may then proceed to the cold chamber 16 of the Stirling engine. The cold fluid may be used as a closed system such that the cold fluid is recycled through the pipe system 320. The cold fluid may be water, oil, or any other suitable heat transfer fluid capable to carrying and transferring cold temperatures to the cold chamber of the Stirling engine.

In other exemplary embodiments, the low temperature source may be any electrically or mechanically chilled device, such as a water cooling tower to provide the low temperature source to the cold chamber 16 of the Stirling engine.

The utilization of water as the medium for heat transfer from deep within the earth's crust may cause corrosion of a metal pipe system. Hot water, especially when containing oxygen, may rapidly corrode metal. To reduce corrosion, a de-oxygenation mechanism, such as a high vacuum, may be employed to remove oxygen from the water. Alternatively, non-corrosive metals such stainless steel may be used for the pipe system. In another embodiment, the pipe system may include high temperature resistant and non-corrosive plastic piping. An exemplary embodiment of the plastic piping is piping manufactured from PARMAX® materials. One of ordinary skill in the art will appreciated that any non-corrosive and temperature resistant plastic may be used. In yet another embodiment, corrosive preventative substances may be used to minimize corrosion. For example, chromates or other chemicals may be used. As an alternative to water, a non-corrosive heat transfer fluid such as a synthetic, natural, or agricultural oil may be used to absorb the heat from within the earth's crust for the high temperature source. Oil has the added advantage of being able to be heated to a higher temperature than water and therefore more power may be drawn from the Stirling engine system in this manner.

The Stirling engine must be protected from the low temperature source during operation to extend the life of the Stirling engine. Protection may be in the form of chemical protection or any other source. The cold chamber may include ceramic materials to resist corrosion from the water. The Stirling engine also may be sealed such that water does not engage or corrode the thermopiles.

The Stirling engine system may have several advantages over conventional systems of power generation. For example, the Stirling engine system has minimal pollution concerns due in part to its operation as a closed loop system and will rely upon minimal, if any, introduction of non-natural materials. The Stirling engine system will have minimal waste and minimal atmospheric emissions. The Stirling engine system also is completely renewable. The Stirling engine system also may be scaled down to a level which can provide power for a local area. The Stirling engine system may be inexpensive to construct and operate compared to conventional power systems and also may take advantage of non-producing oil wells instead of having to cap the wells that are non-productive or to drill new holes.

It should be apparent that the foregoing relates only to exemplary embodiments of the present application and that numerous changes and modifications may be made herein without departing from the spirit and scope of the application as defined herein.

1. A system for generating power comprising:
a Stirling engine; and
a high temperature source thermally coupled to a hot chamber of the Stirling engine wherein the high temperature source comprises heat from below the earth's surface.

2. The system of claim 1 wherein the high temperature source is selected from a group consisting of a dry hole, oil well, and gas well.

3. The system of claim 1, further comprising:
a pipe system extending to the high temperature source and returning to the earth's surface; and
a heat transfer fluid, wherein the heat transfer fluid is pumped into the pipe system to access the high temperature source and heated by the high temperature source and thermally coupled to the hot chamber of the Stirling engine.

4. The system of claim 3, wherein the pipe system comprises a pipe comprising an interior pipe section and an exterior pipe section, wherein the heat transfer fluid may be transported to the high temperature source through an annulus formed between the interior pipe section and the exterior pipe section and transported from the high temperature source to the hot chamber of the Stirling engine in the interior pipe section.

5. The system of claim 3, wherein the pipe system comprises a pipe comprising an interior pipe section and an exterior pipe section, wherein the heat transfer fluid may be transported to the high temperature source through the interior pipe section and transported from the high temperature source to the hot chamber of the Stirling engine through an annulus formed between the interior pipe section and the exterior pipe section.

6. The system of claim 1, wherein the Stirling engine is connected to a electric generator to create electricity.

7. The system of claim 1, further comprising a low temperature source thermally coupled to a cold chamber of the Stirling engine.

8. The system of claim 7 wherein the low temperature source comprises an ambient air.

9. The system of claim 7 wherein the low temperature source comprises water from a body of water.

10. The system of claim 7, wherein the water is from a location below a thermocline of the body of water.

11. The system of claim 10, wherein the body of water is chosen from the group consisting of an ocean, sea, gulf, river, stream, creek, lake, stream, and spring.

12. The system of claim 7 wherein the low temperature source is thermally coupled to the cold chamber using a closed pipe system.

13. The system of claim 7 wherein the low temperature source comprises a mechanically or electrically chilled device.

14. The system of claim 7 wherein the mechanically or electrically chilled device comprises a water cooling tower.

15. A system for generating power comprising:
a Stirling engine;
a high temperature source thermally coupled to a hot chamber of the Stirling engine wherein the high temperature source comprises heat from below the earth's surface; and
a low temperature source thermally coupled to the cold chamber wherein the low temperature source comprises a body of water.

16. The system of claim 15, wherein the water is from a location below a thermocline of the body of water.

17. The system of claim 15, wherein the body of water is chosen from the group consisting of an ocean, sea, gulf, river, stream, creek, lake, stream, and spring.

18. The system of claim 15, wherein the body of water is water pumped from within the earth.

19. The system of claim 15, wherein the low temperature source is water from a public water supply.

20. A method for producing electrical power comprising:
providing a Stirling engine comprising a hot chamber and a cold chamber;
thermal coupling the hot chamber to a high temperature source wherein the high temperature source comprises heat from below the earth's surface; and
generating electricity through a electric generator attached to the Stirling engine.

21. The method of claim 20, further comprising:
thermal coupling the cold chamber to a low temperature source wherein the low temperature source is ambient air.

22. The method of claim 20, further comprising:
thermal coupling the cold chamber to a low temperature source wherein the low temperature source is a body of water.
